(19) United States
(12) Patent Application Publication
(10) Pub. No.: US 2009/0025386 A1
(43) Pub. Date: Jan. 29, 2009

(54) Electrically assisted turbocharger

(76) Inventor: Peer Rumsby, Epinal (FR)

Correspondence Address: HONEYWELL TURBO TECHNOLOGIES, 23326 HAWTHORNE BOULEVARD, SUITE #200, TORRANCE, CA, 90505, US

(21) Appl. No.: 11/665,191

(22) PCT Filed: Oct. 12, 2004
(86) PCT No.: PCT/EP04/11433

§ 371 Date: Apr. 12, 2007

(51) Int. Cl. F02B 37/10; F02B 39/10; F04D 29/056; F04D 29/58

(52) U.S. Cl. 60/607; 417/423.13; 415/116

(57) ABSTRACT

An electrically assisted turbocharger is provided having an electric motor cartridge comprising a first cartridge housing portion (2) and a second cartridge housing portion (3). The cartridge housing portions (2, 3) are coupled together so as to assembly the electric motor cartridge (1) by radially and axially positioning a stator (4) there between. A shaft (34) is supported by a ball bearing assembly (35).

The invention relates to a turbocharger electrically assisted by an electric motor.

Turbochargers are well-known and widely used in combustion engines. Herein, exhaust gas coming from the engine is supplied to a turbine wheel which drives a compressor wheel for compressing air which is charged to the combustion chambers of respective cylinders. The thus compressed air provides the combustion chamber with more oxygen to enhance the combustion and to thus generate more power. However, as exhaust gas having a smaller pressure is supplied to the turbine wheel when the rotation speed of the engine is low, the air supplied to the combustion chamber is compressed less, which results in a so-called “turbo-lag” for low speed ranges. A known solution for overcoming this turbo-lag is to provide an electric motor for the turbocharger, which additionally rotates the compressor wheel when the rotational speed of the engine is low for securing the pressure of the air supplied to the combustion chamber.

According to document U.S. Pat. No. 6,449,950 B1, there is provided a turbocharger having an electric motor for assisting the rotation of a rotor employing a shaft carrying a turbine wheel accommodated in a turbine housing and a compressor wheel accommodated in a compressor housing. The shaft is supported by a bearing accommodated in a center housing, and the electric motor is accommodated by both the compressor housing and a motor housing casting. The center housing is located between the motor housing casting and the turbine housing.

It is the object of the invention to provide an enhanced turbocharger electrically assistable by an electric motor.

According to one aspect of the invention, the above object is achieved by an electrically assisted turbocharger as defined in claim 1. According to another aspect of the invention, the above object is achieved by an electrically assisted turbocharger as defined in claim 25.

Preferable embodiments of the electrically assisted turbocharger are set forth in the dependent claims.

According to the technical solution defined in claim 1, an electrically assisted turbocharger comprises a shaft for supporting a turbine wheel and a compressor wheel, and an electric motor for driving said shaft, said shaft being supported by a ball bearing assembly. Furthermore, said electric motor comprises an electric motor cartridge which is disposed axially outside said bearing assembly and between said turbine wheel and said compressor wheel.

With the construction according to the present invention, the requirement of an improved support structure is dealt with. In particular, the combination of a turbocharger requiring a high operational precision at high rotational speed with the electrically assisted property of the turbocharger increases the demand of a novel support structure which is achieved by the structure according to claim 1. That is, the ball bearing assembly provides a string and precise support of the shaft while the system including the cartridge design of the motor decreases the load applied to the shaft, thereby enabling the motor driving the shaft at a free end of the shaft which is arranged outside the ball bearing assembly.

According to a preferable embodiment, said electric motor cartridge is disposed axially between said ball bearing assembly and said compressor wheel. According to another preferable embodiment, said electric motor cartridge is disposed axially between said ball bearing assembly and said turbine wheel. Both of the above embodiments have the effect that the motor cartridge is arranged very close to one of the ball bearings of the ball bearing assembly so as to reduce the bending moment applied to the shaft. Thereby, the dimensions of the shaft can be reduced.

According to a preferable embodiment, said ball bearing assembly consists of two axially spaced ball bearings. Such a structure improves the reliability of the system while employing the minimum number of bearings.

According to a preferable embodiment, said ball bearing assembly includes a lubricant supply arrangement for supplying a lubricant to said ball bearings. According to a preferable embodiment, said lubricant supply arrangement includes a spacer for axially spacing said ball bearings, and comprises at least one lubricant passage. By such a lubricant passage, the reliability of the bearing assembly can be enhanced.

According to a preferable embodiment, said electric motor cartridge further comprises a first cartridge housing portion; and a second cartridge housing portion; wherein the cartridge housing portions are coupled together so as to assembly the electric motor cartridge by radially and axially positioning a stator therebetween. According to an embodiment of the invention, each cartridge housing portion of the electric motor cartridge has a semi-shell shape substantially comprised by a bottom portion and a cylindrical wall portion. The structure according to the above embodiments facilitates not only the assembly but also the entire structure while reducing the parts forming the cartridge.

At least one of the cartridge housing portions can be provided with at least one recess portion formed at the inner side of the axial end portion of the cylindrical wall portion which extends at least partially in the circumferential direction of the cylindrical wall for receiving a projection of the stator. In this way, a very simple and effective means is provided for engaging the stator between the two housing portions of the cartridge and for thereby radially and axially positioning the stator.

By providing each cartridge housing portion with one recess portion, wherein the recess portions are symmetrically to a plane defined by the abutting tips of the cylindrical wall end portions, positive effects can be achieved in view of unwanted forces, such as moments due to eccentricities.

Furthermore, each cartridge housing portion can provide a bore in the center of its bottom portion, and at least one of the bottom portions can be formed at least partly concave inwardly. The center bore can serve as a guide for a rotor member of the motor which, due to the central position of the center bore, can be positioned optimally in the best possible way. By forming the bottom portion concavely the cartridge can be adapted to the shape of other members of the turbocharger, such as the compressor wheel or a washer plate, without wasting space for the stator which may be larger in the axial direction compared to the rotor.

Additionally at least one contact area can be formed at each of the cartridge housing portions so as to be in contact with respective counter contact areas of two housings between which the cartridge is fittable. Thus an appropriate engagement of the cartridge between two housing portions is ensured without the need of further means for fixing the cartridge.

For sealing between the cartridge housing and one of the two housings between which the cartridge is fittable in at least one of the cartridge housing portions, a circumferentially extending groove can be disposed so as to receive an O-ring. Thus a sealing is automatically provided when inserting the cartridge to the center housing, and the sealing means can advantageously be mounted to the outer surface of the cartridge instead of mounting it into a cavity of the center housing, in which the cartridge is inserted.

Additionally cooling slits and any integrated piping for motor cooling can be disposed in at least one of the cartridge housing portions, which helps to reduce the number of parts.

As material for the electric motor cartridge punched metal, any polymer potted material, any die casting material or any sand casting material can be used to thus achieve an enhanced burst containment.

Additionally, the properties of the material of the cartridge housing can contribute to heat evacuation and heat protection.

Furthermore, the material properties of the cartridge housing can contribute to electromagnetic interference protection.

For connecting phases and sensor connections, the electric motor cartridge can comprise a connector portion at at least one of the electric motor cartridge portions. The connection portion can plug directly to wiring end portions during assembly so as to facilitate the assembly process.

According to a preferable embodiment, in the electric motor cartridge according to any of the above-mentioned aspects, a rotor is encompassed by the stator. Thus the electric motor is received as a separate function if needed. The encapsulation by the cartridge protects any electrical and electronical components during handling and assembly. Furthermore the electric motor acts as a self-centering module that positions the stator and the rotor during the assembly process.

Furthermore, the rotor can comprise two peripheral portions each having a smaller diameter compared to the diameter of a middle portion of the rotor encompassed by the stator, wherein each peripheral portion comprises a circumferential groove provided with a piston ring for sealing between the inside and the outside of the cartridge. This further contributes to the self centering function and helps minimizing the number of components.

Preferably, mechanical balancing of the rotor can be achieved by material removal areas located on said rotor, providing a unitary rotational mass distribution of the rotor. The material removing areas are preferably provided on the circumference of the first and/or second small diameter peripheral portions or on the side of the large diameter portion of the rotor.

For detecting the speed of the rotor, the electric motor can comprise a sensor member.

Additionally, phases and sensor connections can be arranged in the connector portion such that they directly plug to wiring end connections when assembling the compressor motor so as to facilitate the assembling process.

According to a further option, a turbocharger comprises an electric motor and further comprises a turbine housing for accommodating a turbine wheel driven by exhaust gas, a center housing for accommodating a shaft and the electric motor, wherein the shaft serves as a rotor of the electric motor and extends from the turbine wheel through a journal bearing and the electric motor to a compressor wheel, and a compressor housing for accommodating the compressor wheel, wherein the compressor wheel is driven by the turbine wheel via the shaft and can additionally be driven by the electric motor, and wherein the electric motor is accommodated in the center housing such that the compressor motor is firmly fixed by connecting the center housing to the compressor housing, said shaft being supported by a ball bearing assembly, wherein said electric motor is disposed axially outside said bearing assembly and between said turbine wheel and said compressor wheel.

Thus the number of housing parts is minimized as the electric motor provided with the cartridge can directly be inserted into the center housing without the need of further housing parts.

Additionally, one of the cartridge housing portions can serve as a seal plate on the journal bearing side, and the other cartridge housing portion can serve as a backing plate on the compressor wheel side. Thus the number of components is minimized further.

Preferably, said electric motor is disposed axially between said ball bearing assembly and said compressor wheel. Preferably, said electric motor is disposed axially between said ball bearing assembly and said turbine wheel. Preferably, said ball bearing assembly consists of two axially spaced bearings. Preferably, said ball bearing assembly includes a lubricant supply arrangement for supplying a lubricant to said ball bearings. Preferably, said lubricant supply arrangement is formed as a spacer for axially spacing said ball bearings and includes at least one lubricant passage. Preferably, one of the cartridge housing portions serves as a seal plate on the ball bearing assembly side and the other cartridge housing portion serves as a backplate on the compressor wheel side.

According to the foregoing preferable forms, the same advantages as those of the previous option can be achieved.

According to a further option, a compressor comprises an electric motor as described above and further comprises a motor housing for accommodating a shaft and the electric motor, the shaft serving as a rotor of the electric motor and carrying a compressor wheel, and comprises a compressor housing for accommodating the compressor wheel, wherein the electric motor is accommodated in the motor housing such that the compressor motor is firmly fixed by connecting the motor housing to the compressor housing. Thus, an electrically driven compressor (EDC) can be improved by use of an electric motor implemented to the cartridge as described above.

Thus, according to the invention, the concept of having a cartridge for the electric motor to be assembled to the turbocharger or the EDC type compressor provides an encapsulation of the electric motor that protects it from oil and water and that contributes to a limitation of fire propagation. Additionally, the cartridge achieves noise and vibration damping and can be adapted to any motor geometric definition, rotor bearing size and turbocharger size. Furthermore, the cartridge concept allows a pre-testing of the electric motor before assembling the same to the turbocharger.

In the following, further technical solutions of the object of the invention are described in detail, with reference being made to the enclosed drawings, in which:

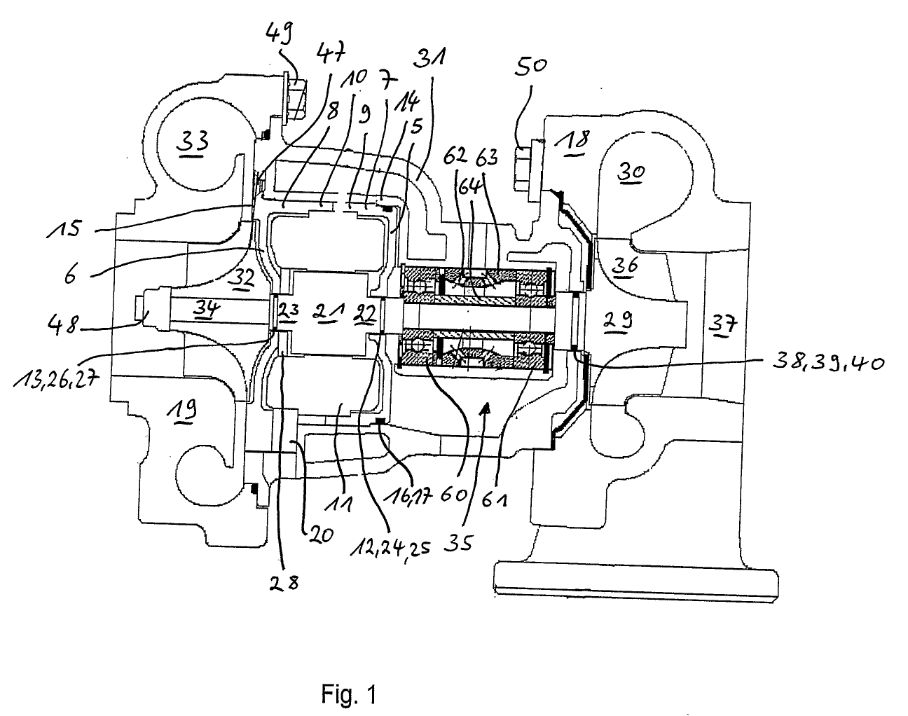

FIG. 1 is a sectional view of the turbocharger having the electric motor cartridge according to one embodiment of the invention.

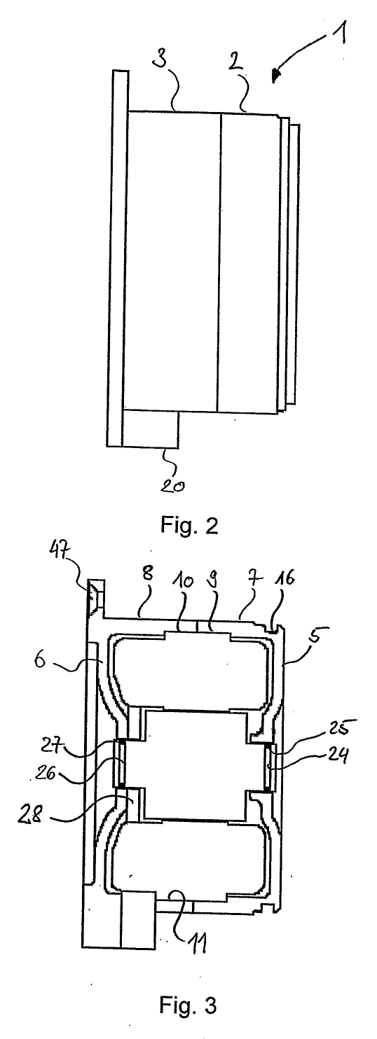

FIG. 2 is a side view of the electric motor cartridge according to one embodiment of the invention.

FIG. 3 is a sectional view of the electric motor cartridge shown in FIG. 2.

An electrically assisted turbocharger according to the embodiment shown in FIG. 1 substantially comprises a turbine housing 18 for accommodating a turbine wheel 29, a center housing 31 for accommodating an electric motor cartridge 1, and a compressor housing 19 for accommodating a compressor wheel 32. A shaft 34 extends through the center housing 31 and the electric motor cartridge 1 (FIG. 2) accommodated therein so as to connect the compressor wheel 32 to the turbine wheel 29, wherein the shaft 34 can serve as a rotor of an electric motor disposed in the cartridge 1.

The electric motor is substantially constituted by a rotor 21, a stator 4 and a sensor 28, which are incorporated into a first cartridge housing portion 2 and a second cartridge housing portion 3 providing also a connector 20 for supplying electrical energy and control signals to the electric motor.

The rotor 21 has a cylindrical shape with an axially extending through hole for inserting the shaft 34 through the rotor 21. A first peripheral portion 22 and a second peripheral portion 23 of the rotor 21, each having a smaller diameter compared to the middle portion thereof, are provided with circumferential grooves 24, 26 for accommodating piston rings 25, 27, respectively.

The stator 4 is ring-shaped and designed to coaxially encompass the rotor 21. That means the inner diameter of the stator 4 is slightly greater than the outer diameter of the rotor 21. Furthermore, the stator 4 comprises a projection 11 which at least partly extends over the peripheral surface of the rotor 21 at a middle portion in a circumferential direction.

The first cartridge housing portion 2 and the second cartridge housing portion 3 are substantially cup-shaped and a bottom portion 6 of the second cartridge housing portion 3 is concavely curved inwardly so that it does not abut against a compressor wheel 32. Furthermore, the bottom portion 6 provides for a thrust bearing face 15 for abutting against the compressor housing 19 and comprises a central opening 13 for receiving the second peripheral portion 23 of the rotor 21.

A circumferential recess 9 is formed at the inner side of the axial end portion of a cylindrical wall portion 8 of the cup-shaped first cartridge housing portion 3.

Also a bottom portion 5 of the first cartridge housing 2 is concavely curved inside to adapt to a washer plate 46, and has a circumferential recess 10 formed at the axial end portion of the first cartridge housing 2 of a cylindrical cartridge wall portion 7 on the inner side thereof. Furthermore, an O-ring 17 is disposed on an outer peripheral position of the transition between the bottom portion 5 and the wall portion 7 of the first cartridge housing 2.

Thus, an electric motor cartridge can be easily assembled by first disposing the stator 4 into the second cartridge housing 3 whereby the projection 11 of the stator 4 is received by the recess 10 and thus a gap between the stator 4 and the housing 3 is maintained. Next, the sensor 28 having a ring shape can be laid into the ring-shaped stator 4 such that an opening of the sensor 28 is aligned with the opening in the second cartridge housing 3, and then the rotor 21 can be inserted into the inside of the ring-shaped stator 4 by inserting the portion 23 having the smaller diameter through the opening of the ring-shaped sensor 28 and central opening 13 of the bottom portion 6 of the second cartridge housing portion 3. Now, the first cartridge housing 2 can be attached to the rest of the assembly by inserting the portion 22 of the stator 4 into the central opening 12 of the first cartridge housing 2. The piston rings 25 and 27 tightly close the gaps between the first and second portions 22 and 23 of the rotor 21 and the inner peripheral faces of the openings 12, 13 in the respective cartridge housings 2, 3.

Thus, as described above, the electric motor cartridge is assembled without being mounted to the turbocharger. That means, the electric motor cartridge can be produced in a separate process for being mounted to the turbocharger later.

Next, the turbocharger having the electric motor cartridge is described.

The shaft 34 of the turbocharger is connected to a turbine wheel 29 accommodated in the turbine housing 18. Exhaust gas enters the turbine housing 18 through a volute 30 to drive the turbine wheel 29 through the turbine blades 36 and exits through an outlet 37. The turbine includes a hub portion 38 that incorporates a groove 39 to retain a piston ring 40. A heat shroud 41 is engaged between the turbine housing 18 and the center housing 31 for thermal aerodynamic control enhancement. The turbocharger further includes a bearing assembly 35 having ball bearings 60 and 61.

In the following, the ball bearing assembly 35 is described in more detail. The ball bearing assembly 35 is formed by said two axially spaced ball bearings 60, 61. The ball bearings 60, 61 are spaced by a spacer 64 which is interposed between the ball bearings. The shaft 34 penetrates the inner rings of the ball bearings 60, 61 and the spacer 64. The spacer 64 is surrounded by a tubular element 63 which serves as a lubricant supply arrangement 62, 63 in cooperation with openings 62 which penetrate the tubular element in a radial direction. A lubricant can be supplied directly towards the ball bearings 60, 61 and can be drained from the same.

The electric motor cartridge is slid over the shaft 34 such that the end face of the first peripheral portion 22 of the rotor 21 abuts against the bearing 60. In this state, the electric motor cartridge is entirely disposed inside the center housing 31 and is secured thereto by cartridge screws 47. In this state, the O-ring 17 seals between the inside of the center housing 31 and the cartridge. After the compressor wheel 32 is attached to the shaft 34, the compressor housing 29 can directly be fitted to the center housing 31, thereby engaging the electric motor cartridge between the compressor housing 19 and the center housing 31 via contact areas 14, 15 of the cartridge. As the peripheral portions 22 and 23 slightly extend outside the respective cartridge housing 2, 3, a clearance is established between the second cartridge housing 3 and the compressor wheel 32, as well as between the first cartridge housing 2 and the bearing 60. Additionally, a lock nut 48 is provided for securing the compressor wheel 32 to the shaft 34. Finally, the compressor housing 19 and the turbine housing 18 are secured to the center housing 31 via bolts 49 and 50.

The invention is not restricted to the above-described embodiments and can be changed in various modifications.

For example, the projection 11 of the stator does not have to continue throughout the whole circumferential extent, but may be divided in any number of projections. Accordingly, the recesses 9, 10 do not have to be continuously, but may be interrupted at corresponding intervals.

1. An electrically assisted turbocharger having a shaft (34) for supporting a turbine wheel (36) and a compressor wheel (32), and an electric motor for driving said shaft (34), said shaft (34) being supported by a ball bearing assembly (35), wherein said electric motor comprises an electric motor cartridge (1) which is disposed axially outside said bearing assembly (35) and between said turbine wheel (36) and said compressor wheel (32).

2. An electrically assisted turbocharger according to claim 1, wherein said electric motor cartridge (1) is disposed axially between said ball bearing assembly (35) and said compressor wheel (32).

3. An electrically assisted turbocharger according to claim 1, wherein said electric motor cartridge (1) is disposed axially between said ball bearing assembly (35) and said turbine wheel (36).

4. An electrically assisted turbocharger according to any one of claims 1 to 3, wherein said ball bearing assembly (35) consists of two axially spaced ball bearings (60, 61).

5. An electrically assisted turbocharger according to any one of claims 1 to 4, wherein said ball bearing assembly (35) includes a lubricant supply arrangement (62, 63) for supplying a lubricant to said ball bearings (60, 61).

6. An electrically assisted turbocharger according to claim 5, wherein said lubricant supply arrangement includes a spacer (63) for axially spacing said ball bearings (60, 61) and comprises at least one lubricant passage (62).

7. An electrically assisted turbocharger according to any one of claims 1 to 6, wherein said electric motor cartridge (1) comprises
a first cartridge housing portion (2); and
a second cartridge housing portion (3);
the cartridge housing portions (2, 3) being coupled together so as to assembly the electric motor cartridge (1) by radially and axially positioning a stator (4) there between.

8. An electrically assisted turbocharger according to claim 7, wherein each cartridge housing portion (2, 3) has a semi-shell shape substantially comprised by a bottom portion (5, 6) and a cylindrical wall portion (7, 8).

9. An electrically assisted turbocharger according to claim 8, wherein at least one of the cartridge housing portions (2, 3) is provided with at least one recess portion (9, 10) formed at the inner side of the axial end portion of the cylindrical wall portion (7, 8) which extends at least partially in the circumferential direction of the cylindrical wall (7, 8) for receiving a projection (11) of the stator (4).

10. An electrically assisted turbocharger according to claim 9, wherein each cartridge housing portion (2, 3) is provided with one recess portion (9, 10), wherein the recess portions (9, 10) are symmetrically to a plane defined by the abutting tips of the cylindrical wall end portions.

11. An electrically assisted turbocharger according to claim 10, wherein each cartridge housing portion (2, 3) provides a bore (12, 13) in the center of its bottom portion (5, 6).

12. An electrically assisted turbocharger according to claim 11, wherein at least one of the bottom portions (5, 6) is formed at least partly concave inwardly.

13. An electrically assisted turbocharger according to claim 12, wherein at least one contact area (14, 15) is formed at each of the cartridge housing portions (2, 3) so as to be in contact with respective counter contact areas of two housings (18, 19) between which the cartridge (1) is fittable.

14. An electrically assisted turbocharger according to claim 13, wherein in at least one of the cartridge housing portions (2, 3) a circumferentially extending groove (16) is disposed so as to receive an O-ring (17) for sealing between the cartridge housing (2, 3) and one of the two housings (18, 19) between which the cartridge (1) is fittable.

15. An electrically assisted turbocharger according to any one of claims 7 to 14, wherein cooling slits and any integrated piping for motor cooling is integrated in at least one of the cartridge housing portions (2, 3).

16. An electrically assisted turbocharger according to any one of claims 7 to 15, wherein the cartridge housing (2, 3) is made of punched metal, any polymer potted material, any die casting material or any sand casting material.

17. An electrically assisted turbocharger according to claim 16, wherein the properties of the material of the cartridge housing (2, 3) contributes to heat evacuation and heat protection.

18. An electrically assisted turbocharger according to any of claims 7 to 17, wherein the material properties of the cartridge housing contributes to electromagnetic interference protection.

19. An electrically assisted turbocharger according to any of claims 7 to 18, wherein at least one of the cartridge housings (2, 3) comprises a connector portion (20) for phases and sensor connections of an compressor motor.

20. An electrically assisted turbocharger according to any of claims 7 to 19, comprising a rotor (21) being encompassed by the stator (4).

21. An electrically assisted turbocharger according to claim 20, wherein the rotor (21) comprises two peripheral portions (22, 23) each having a smaller diameter compared to the diameter of a middle portion of the rotor (21) encompassed by the stator, each peripheral portion (22, 23) comprising a circumferential groove (24, 26) provided with a piston ring (25, 27) for sealing between the inside and the outside of the cartridge (1).

22. An electrically assisted turbocharger according to claim 20 or 21, further comprising material removal areas on said rotor (21) providing a unitary rotational mass distribution of the rotor.

23. An electrically assisted turbocharger according to one of claim 20 to 22, further comprising a sensor member (28) for detecting the speed of the rotor (21).

24. An electrically assisted turbocharger according to any of claims 20 to 23, wherein phases and sensors connections are arranged in the connector portion (20) such that they plug directly to wiring end connections when assembling the compressor motor.

25. An electrically assisted turbocharger comprising an electric motor and further comprising
a turbine housing (18) for accommodating a turbine wheel (29) driven by exhaust gas;
a center housing (31) for accommodating a shaft (34) and the electric motor, the shaft serving as a rotor (21) of the electric motor and extending from the turbine wheel (29) and the electric motor to a compressor wheel (32);
a compressor housing (19) for accommodating the compressor wheel (32); wherein
the compressor wheel (32) is driven by the turbine wheel (29) via the shaft (34) and can additionally be driven by the electric motor, and
the electric motor is accommodated in the center housing (31) such that the compressor motor is firmly fixed by connecting the center housing (31) to the compressor housing (19), said shaft being supported by a ball bearing assembly (35),
wherein said electric motor is disposed axially outside said bearing assembly (35) and between said turbine wheel (36) and said compressor wheel (32).

26. An electrically assisted turbocharger according to claim 25, wherein said electric motor is disposed axially between said ball bearing assembly (35) and said compressor wheel (32).

27. An electrically assisted turbocharger according to claim 25, wherein said electric motor is disposed axially between said ball bearing assembly (35) and said turbine wheel (36).

28. An electrically assisted turbocharger according to any one of claims 25 to 27, wherein said ball bearing assembly (35) consists of two axially spaced bearings (60, 61).

29. An electrically assisted turbocharger according to any one of claims 25 to 28, wherein said ball bearing assembly (35) includes a lubricant supply arrangement (62, 63) for supplying a lubricant to said ball bearings (60, 62).

30. An electrically assisted turbocharger according to claim 29, wherein said lubricant supply arrangement (62, 63) is formed as a spacer (63) for axially spacing said ball bearings (60, 61) and includes at least one lubricant passage (62).

31. An electrically assisted turbocharger according to any one of claims 25 to 30, wherein one of the cartridge housing portions (2) serves as a seal plate on the ball bearing assembly (35) side and the other cartridge housing portion (3) serves as a backplate on the compressor wheel (32) side.
